(19) United States
(12) Patent Application Publication
(10) Pub. No.: US 2015/0129619 A1
(43) Pub. Date: May 14, 2015

(54) DROPPER FOR DISPENSING DROPS OF A FLUID, DROPPER-CAP SYSTEM AND CONTAINER WITH SUCH A DROPPER OR DROPPER-CAP SYSTEM

(71) Applicant: pheneo GmbH, Bremen (DE)

(72) Inventors: Michael ESSLER, Cuxhaven (DE); Sasan HABIBI-NAINI, Fischerhude (DE)

(21) Appl. No.: 14/535,771

(22) Filed: Nov. 7, 2014

(30) Foreign Application Priority Data
Nov. 8, 2013 (DE) 10 2013 018 707.9
Feb. 3, 2014 (DE) 10 2014 001 247.6

(51) Int. Cl. B65D 47/18; B01L 3/02

(52) U.S. Cl. CPC B65D 47/18; B01L 3/0272
USPC 222/420

(57) ABSTRACT

A dropper (10) for dispensing drops of a fluid from a container includes a dropping channel (12), which has a dropping channel inlet (13) for introducing the fluid into the dropping channel (12) and a dropping channel outlet (14) for dispensing drops from the dropping channel (12). The dropping channel (12) has a conical channel area (16) and a cylindrical channel area (15). The dropping channel inlet (13) is designed as an end of the cylindrical channel area (15), facing away from the conical channel area (16). To make it possible to better meter the quantities of drops that can be dispensed and to markedly reduce the dispensed quantities, the dropping channel outlet (14) is designed as an end of the conical channel area (16), facing away from the cylindrical channel area (15).

### CROSS REFERENCE TO RELATED APPLICATIONS

This application claims the benefit of priority under 35 U.S.C. §119 of German Patent Application DE 10 2013 018 707.9 filed Nov. 8, 2013 and German Patent Application DE 10 2014 001 247.6, filed Feb. 3, 2014, the entire contents of which are incorporated herein by reference.

### FIELD OF THE INVENTION

The present invention pertains to a dropper for dispensing drops of a fluid from a container, with a dropping channel, which has a dropping channel inlet for introducing the fluid into the dropping channel and a dropping channel outlet for dispensing drops from the dropping channel, and the inlet of the dropping channel is designed as an end of the cylindrical channel area facing away from the conical channel area. Furthermore, the present invention pertains to a dropper-cap system as well as to a container, especially a bottle, with such a dropper or dropper-cap system.

### BACKGROUND OF THE INVENTION

A dropper, in which a conical channel area, which expands starting from the inlet of the dropping channel in the direction of a dropping channel outlet, is associated with the inlet of the dropping channel, is known from DE 197 13 951 B4. A cylindrical channel area, whose end facing away from the conical channel area forms the outlet of the dropping channel, adjoins at an end of the conical channel area, which end faces away from the inlet of the dropping channel.

It is disadvantageous in the prior-art dropper that the desired dispensed quantity or drop size can often be metered only insufficiently. As a result, there is especially a risk that more fluid is dispensed than is actually necessary for the intended use. Fluid is thus needlessly discharged, which leads to higher costs. Especially when mixing two components of a two-component material, there is an increased risk that the components to be mixed with one another are not mixed with one another at the preset mixing ratio. This leads to the risk that the desired properties of the two-component material are adversely affected because of an unfavorable mixing ratio of the two components. In addition, it is disadvantageous that, at least in respect to one of the two components, there often is a large quantity of lost fluid, which leads to increased costs.

### SUMMARY OF THE INVENTION

A basic object of the present invention is therefore to further improve a dropper of the type mentioned in the introduction such that the quantities of drops that can be dispensed can be metered better and/or the quantities of lost fluid can be markedly reduced.

The basic object of the present invention is accomplished by a dropper of the type mentioned in the introduction, in which the outlet of the dropping channel is designed as an end of the conical channel area, which end faces away from the cylindrical channel area.

It is advantageous here that based on the cylindrical channel area, which is associated with the inlet of the dropping channel and/or adjoins the inlet of the dropping channel, it is possible to achieve, in particular, controllable shearing for the fluid. The cylindrical channel area is used, in particular, based on its shearing force effect on the fluid, to reduce the viscosity of the fluid. The viscosities of different fluids can be advantageously brought closer to one another by means of the shearing force effect of the cylindrical channel area. As a result, very similar drop sizes and/or dispensed quantities can be obtained hereby, especially with the same dropper, even for different fluids with viscosities that differ from each other. Furthermore, a nonuniform flow may become established during the transition of the fluid from a container through the dropping channel inlet into the dropping channel. The cylindrical channel area is preferably designed such that an at least largely established, stationary, uniform and/or reproducible flow is achieved for the fluid already within the cylindrical channel area. In particular, an at least largely established, stationary, uniform and/or laminar flow is achieved after a flow path of the fluid within the cylindrical channel area in the range of 0.3 to 0.5 times the internal diameter of the cylindrical channel area. In particular, the conical channel area adjoining the cylindrical channel area in the direction of flow makes possible a continuous transition of the flow and/or a globally established, stationary, uniform and/or reproducible flow.

The cylindrical channel area is preferably used to generate a thixotropic and/or intrinsically viscous behavior in a fluid being sent through the cylindrical channel area. Especially in the case of an intrinsically viscous and/or thixotropic fluid, the viscosity decreases, especially in a time-dependent manner, because of a shearing load acting on it. The corresponding fluid thus becomes less and less viscous because of the shearing force effect in the cylindrical channel area. The viscosity increases again, especially in a time-dependent manner, after the cessation of the shear stress. The shearing load preferably has an aftereffect during the passage and flow through the channel area adjoining the cylindrical channel area. Lower viscosity of the fluid can be attained at the outlet of the dropping channel especially because of the cylindrical channel area. Thus, an especially time-dependent shear thinning can be achieved by means of the cylindrical channel area. Smaller drops and/or dispensed quantities can be obtained as a result. Higher yield is thus possible, as a result of which the quantity of lost fluid and/or needless costs are reduced. Especially in connection with the mixing of two components of a two-component material, the dropper according to the present invention makes possible a better, more optimal mixing ratio. It is guaranteed hereby that the two-component material has the desired properties.

Meterable dispensing of the fluid is, in particular, facilitated by means of the dropper according to the present invention. The dropper may be designed such that the drop weight is in the range of 10 mg to 50 mg, especially in the range of 1 mg to 2 mg and preferably about 1.5 mg. The drop volume is preferably in the range of 10 μL (microliter) to 50 μL, especially in the range of 10 μL to 30 μL, and preferably in the range of 10 μL to 20 μL. In case of metering five drops, the deviation may be in the range of ±0.5 mg to about ±2 mg, especially around approximately ±1.5 mg. The diameter of the drop according to the present invention is preferably designed as a function of the viscosity, and the rheological and/or physical properties of the fluid associated with the dropper.

The cylindrical channel area preferably passes over at its end facing away from the inlet of the dropping channel into the conical channel area. The internal diameter of the conical channel area increases, in particular, starting from the cylindrical channel area, in the direction of the outlet of the dropping channel. The conical channel area thus widens starting from the cylindrical channel area and away from the inlet of the dropping channel in the direction of the outlet of the dropping channel. As a result, the risk of development of a nonuniform flow is reduced at the transition from the cylindrical channel area into the downstream channel area. The conical shape of the channel area adjoining the cylindrical channel area can prevent the segregation of the especially filler-containing fluid and/or retard an increase in the viscosity of an especially thixotropic fluid after shearing force effect in the cylindrical channel area. A filler-containing fluid may contain an adhesive, nanoparticles and/or a thixotropic agent. In particular, an end of the conical channel area facing away from the cylindrical channel area is associated with the outlet of the dropping channel. The outlet of the dropping channel is preferably formed by the end of the conical channel area facing away from the cylindrical channel area. The inlet of the dropping channel may be designed as an end of the cylindrical channel area facing away from the conical channel area. In particular, the dropping channel is formed from the cylindrical channel area and the conical channel area.

According to a variant, the cylindrical channel area has a channel length in the range of 0.5 mm to 2.5 mm. The channel length of the cylindrical channel area is especially in the range of 0.7 mm to 2 mm and preferably in the range of 0.9 mm to 1.5 mm. The channel length of the cylindrical channel area especially preferably equals 1 mm. The channel length is selected, in particular, such that a shearing force effect that is sufficiently strong for reducing the viscosity can be achieved by means of the cylindrical channel area.

The cylindrical channel area preferably has an internal diameter in the range of 0.2 mm to 1 mm. The internal diameter of the cylindrical channel area is especially in the range of 0.3 mm to 0.7 mm. The internal diameter of the cylindrical channel area is preferably 0.5 mm or 0.3 mm. In particular, the internal diameter is selected as a function of the channel length of the cylindrical channel area to be such that a sufficient reduction of the viscosity of the fluid can be achieved based on the shearing force effect produced. The shear gradient and/or the shear rate may be in a range of 0.1 per sec to 250 per sec and especially in a range of 10 per sec to 250 per sec.

According to another embodiment, the outlet of the dropping channel has an internal diameter in the range of 1.00 mm to 2.00 mm. The internal diameter of the outlet of the dropping channel is, in particular, in the range of 1.2 mm to 1.8 mm. The internal diameter of the outlet of the dropping channel preferably equals 1.5 mm. The outlet of the dropping channel may have a canted edge, especially with an obtuse angle between a side wall of the conical channel area and an outer wall. In case of a canted edge of the outlet of the dropping channel, a drop of the fluid can be separated from the dropper directly at the canted edge of the outlet of the dropping channel. As an alternative, the edge of the outlet of the dropping channel may be rounded or bent. As a result, larger drops, especially with a larger drop diameter, can be produced. The drop size and/or the dispensed quantity of fluid is preferably determined by the size of the internal diameter of the outlet of the dropping channel.

According to a variant, the dropping channel has an overall length in the range of 4 mm to 8 mm. The overall length of the dropping channel is, in particular, in the range of 5 mm to 7 mm and preferably in the range of 5.2 mm to 6.5 mm. The overall length of the dropping channel is preferably composed of the channel length of the cylindrical channel area and the channel length of the conical channel area. A globally simple design is thus obtained for the dropping channel, but considerably improved drop properties can be obtained because of the cylindrical channel area is arranged first in the direction of flow of the fluid, and it is followed downstream by the conical channel area.

According to another embodiment, the dropping channel is arranged in the cylinder element. The cylinder element may be surrounded by a collection area for collecting overflowing and/or excess fluid. The collection area thus prevents, at least for a preset quantity of fluid, the fluid from flowing down on the dropper and/or on a container connected with the dropper. Undesired contamination can be prevented hereby from occurring. The collection area may be designed as a depression and/or in the manner of a basin. In particular, the collection area has a sink, a groove, a collection collar and/or a raised edge. The overflowing fluid can be flow into a basin, a sink and/or a groove in order to be collected there. In particular, the collection area is designed as a collecting ring. The collecting ring and/or a ring-shaped groove may be arranged such that it surrounds the cylinder element.

An insertion base for inserting and/or fastening the dropper in an opening of a container is preferably arranged under the cylinder element and/or the collection area. The insertion base may have an essentially cylindrical and/or tubular shape. At an end facing away from the collection area and/or the dropping channel, the insertion base may have one or two slots or notches. The slots or notches preferably extend in the direction of the dropping channel. The slots or notches facilitate especially the complete emptying of a container connected with the dropper or the insertion base. The insertion base is designed especially for positive-locking and/or non-positive connection with a container. For example, the insertion base may be inserted into the opening of the neck of the container.

According to a variant, a first dropping channel for a first fluid and a second dropping channel for a second fluid are provided. The first dropping channel and the second dropping channel are preferably aligned in parallel to one another. The two dropping channels are used, in particular, to dispense one component each of a two-component material. The first dropping channel may be provided for connection with a first reservoir for the first fluid and the second dropping channel for connection with a second reservoir for the second fluid. The first reservoir and the second reservoir may be associated with the same container or each with a separate container. In particular, the first dropping channel and the second dropping channel have an identical design. As an alternative, the first dropping channel and the second dropping channel may be coordinated with one another for a preset dispensed quantity and/or for a preset mixing ratio of the fluids from the first reservoir and the second reservoir. The two fluids or the two components can be dispensed in a metered manner from both reservoirs and/or containers in a simple manner and at a desired mixing ratio by means of the first dropping channel and the second dropping channel. The first dropping channel and the second dropping channel may be designed differently from each other and as a function of the viscosity, the rheological and/or physical properties of the fluids associated with the first dropping channel and the second dropping channel. In particular, the shape of the first dropping channel and of the second dropping channel is adapted as a function of the material properties of the respective associated fluid as well as the preset mixing ratio of the two fluids or components. The internal diameter at the inlet of the dropping channel and/or at the outlet of the dropping channel, the channel length of the cylindrical channel area and/or of the conical channel area may be adapted for obtaining the preset mixing ratio. However, the first dropping channel and the second dropping channel preferably have an identical design regardless of the fluid.

A dropper-cap system with a dropper according to the present invention and with a cap for opening and closing the dropper is advantageous. The cap preferably has a stopper for closing the dropping channel. The stopper may enter the dropping channel at least partially. To close the dropping channel, the stopper is at least partially in contact with the inner side of the dropping channel, especially in the area of the conical channel area. The stopper is preferably elastic, as a result of which damage to the stopper or the dropping channel is avoided. As an alternative, the stopper may be rigid and/or the dropper may be elastic. In particular, the cap has a flange for coming into contact with the inner side of the contact area for covering a collection area of the stopper. The inner side of the collection area, with which the flange is in contact, is preferably on a side of the collection area facing away from the cylinder element of the dropper. The cap thus covers the collection area, especially in a position for closing the dropping channel, as a result of which fluid present in the collection area is prevented from flowing out of the collection area. The flange especially has a web-like and/or ring-shaped design.

A container, especially a bottle, with a dropper according to the present invention or with a dropper-cap system according to the present invention is especially advantageous. Such a container permits smaller drops and/or dispensed quantities to be dispensed in a better meterable manner than before. Higher yield can be achieved hereby. Depending on the type of fluid used and with equal dispensed quantity, up to 8%, especially up to 20%, preferably up to 30%, and especially preferably up to 50% more additional drops or applications can be obtained compared to droppers commonly used hitherto.

The container preferably contains a fluid intended for use in dentistry. In particular, the container and/or the dropper is used especially to dispense a medicinal and/or dental fluid, especially a dental material. The fluid is preferably a liquid. The fluid and/or dental material is especially one of the following: A technical bonding agent, a bonding material, especially a self-etching and/or self-adhesive bonding material, a cement liquid, a drug, an endodontic rinsing liquid, a dyeing solution, a resin emulsion (especially with a mixing ball), a ceramic liquid, a bleaching agent and/or an etching agent.

The container is preferably manufactured from a plastic material, especially an elastic one. The container may permit compression at least partially, as a result of which the dispensing of a drop can be influenced. The outlet of the dropping channel is preferably directed upward in a storage position of the container, as a result of which the fluid is prevented from flowing accidentally out of the container. To dispense at least one drop, the container with the dropper is rotated especially such that the outlet of the dropping channel is directed essentially downward.

The dropper has, in particular, a dropping channel section and a base section. The base section may be used to arrange and/or fasten the dropper on a container, especially a bottle. For example, the base section may have a base and/or insertion base for inserting and/or fastening the dropper in an opening of a container. The base section may have an especially cylindrical interior space and/or line section for feeding a fluid to the dropping channel section and/or to the dropping channel, especially the inlet of the dropping channel. The dropping channel is preferably arranged in the dropping channel section. The dropping channel section may be designed as a cylinder element of the dropper. The dropping channel section with the dropping channel is arranged, in particular, downstream in relation to the base section. The base section may thus be arranged upstream in relation to the dropping channel section. The upstream and/or downstream direction of flow of the fluid is obtained especially when the dropper is used to dispense at least one drop from a container with the dropper. The cylindrical channel area passes over at its end facing away from the inlet of the dropping channel into the conical channel area preferably within the dropping channel section and/or the dropping channel. The diameter of the cylindrical channel area corresponds, preferably at the transition of the cylindrical channel area to the conical channel area, especially to the smallest diameter of the conical channel area.

The present invention will be explained in more detail below on the basis of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic sectional side view of a dropper according to the present invention;

FIG. 2 is a schematic sectional side view of the dropper according to the present invention according to FIG. 1 with a cap attached for closing;

FIG. 3 is a schematic sectional side view of another dropper according to the present invention and with containers with first and second reservoirs; and

FIG. 4 is a schematic sectional side view of the dropper according to the present invention according to FIG. 1 with a container;

### DESCRIPTION OF THE PREFERRED EMBODIMENTS

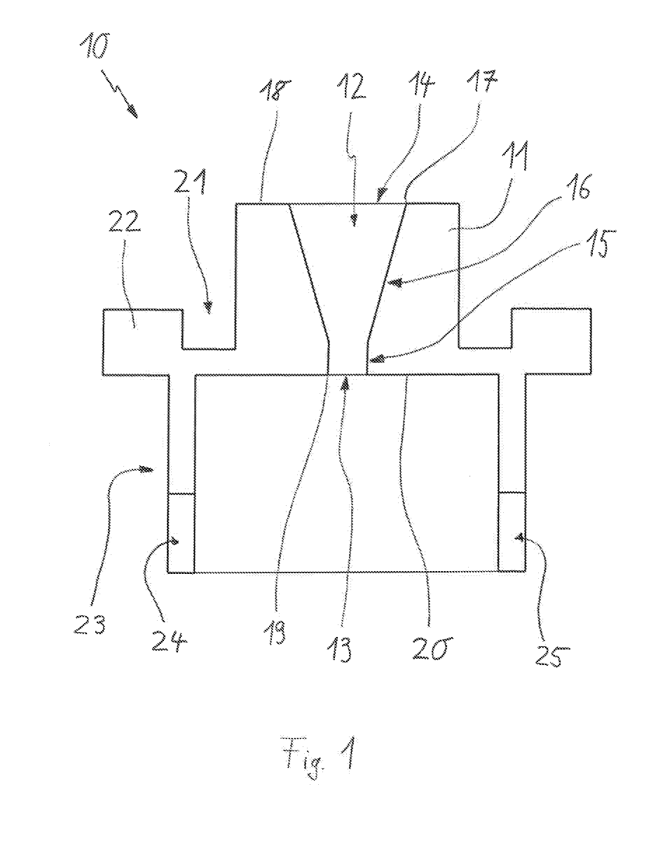

Referring to the drawings, FIG. 1 shows a schematic cut-away side view of a dropper 10 according to the present invention. The dropper 10 has a cylinder element 11, which has a dropping channel 12. The dropping channel 12 is directed coaxially to the longitudinal axis of the cylinder element 11. At its first end in the longitudinal direction of the cylinder element (cylindrical portion) 11, the dropping channel 12 has a dropping channel inlet 13. At a second end of the cylinder element 11 or dropping channel 12 facing away from the dropping channel inlet 13 or the first end, the dropping channel 12 has a dropping channel outlet 14.

The dropping channel 12 is composed in this exemplary embodiment of a cylindrical channel area 15 and a conical channel area 16. The cylindrical channel area 15 is associated here with the dropping channel inlet 13. One end of the cylindrical channel area 15 forms the dropping channel inlet 13. The internal diameter of the dropping channel inlet and of the cylindrical channel area equals 0.5 mm in this exemplary embodiment. The cylindrical channel area 15 has a length of 1 mm according to this example. The conical channel area 16 adjoins at the end of the cylindrical channel area 15 facing away from the dropping channel inlet 13. Starting from the transition of the cylindrical channel area 15 into the conical channel area 16, the conical channel area 16 expands in the direction of the dropping channel outlet 14. The maximum internal diameter of the conical channel area 16 and the diameter of the dropping channel outlet 14 equal 1.3 mm in this exemplary embodiment. The end of the conical channel area 16 facing away from the cylindrical channel area 15 forms the dropping channel outlet 14 here. The dropping channel outlet 14 has, for example, a canted edge 17 here. An obtuse angle is formed here between an inner wall of the conical channel area 16 and an end face or outer wall 18 of the cylinder element 11. The dropping channel inlet 13 likewise has a canted edge 19 in this exemplary embodiment, and a right angle is formed between an inner side of the cylindrical channel area 15 and an inner wall 20, which faces away from the outer wall 18 and is directed in parallel to the outer wall 18. As an alternative to the embodiment of canted edges 17, 19 selected here, the edges 17, 19 may also be rounded.

According to the embodiment being shown here, the cylinder element 11 has a canted edge in the area of the transition from its outer circumference to the end-face outer wall 18. The canted edge forms a right angle here. As an alternative, the edge may be rounded at the transition from the cylindrical outer circumference of the cylinder element 11 to the end-face outer wall 18. A rounded design may facilitate the backflow of the fluid into the dropping channel 12, the dropper 10 and/or a container connected thereto. A sharp-edged design of the edge can bring about better separation of the drop formed.

Furthermore, the dropper 10 has a collection area 21. In this exemplary embodiment, the collection area 21 is led around and arranged on the outer circumference of the cylinder element 11 in a ring- or groove-like manner. An inner side of the collection area 21 is formed by the outer side of the cylinder element 11. The outer side of the collection area 21 is formed by a ring 22 extending around the cylinder element 11. To form the collection area 21, the internal diameter of the ring 22 is larger than the external diameter of the cylinder element 11. The internal diameter of the ring 22 is larger in this exemplary embodiment by about 4 mm than the external diameter of the cylinder element 11.

Starting from the inner wall 20 and approximately under the collection area 21, an essentially tubular insertion base 23, which is directed away from the inner wall 20, extends coaxially to the cylinder element 11 and the dropping channel 12. The dropper 10 has a one-piece design in this exemplary embodiment and is made of a plastic. The dropper 10 is made of a polyethylene here. As an alternative, the dropper 10 may be made of another suitable plastic material, for example, a polypropylene or a thermoplastic elastomer.

According to this exemplary embodiment, the insertion base 23 has notches 24, 25 at an end facing away from the cylinder element 11. The notches 24, 25 are arranged on two sides of the insertion element 23, which sides face away from one another. The notches 24, 25 extend from the free end of the insertion nozzle 23 in the direction of the inner wall 20 or the cylinder element 11.

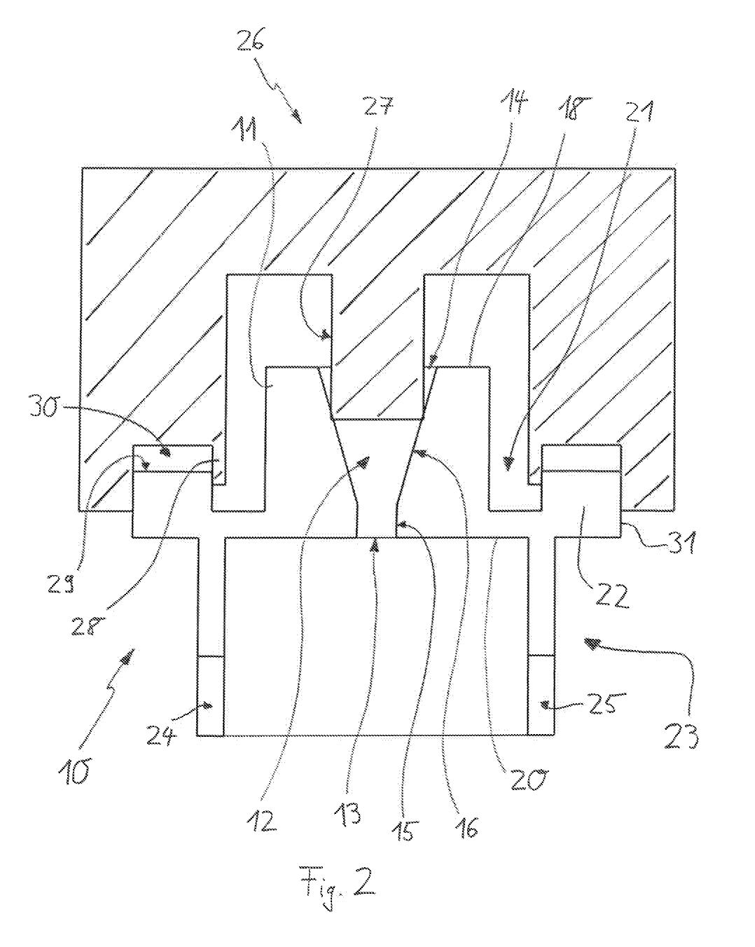

FIG. 2 shows a schematic cut-away side view of the dropper 10 according to FIG. 1 with a cap 26 attached to close the dropping channel 12. The cap 26 has a stopper 27. The external diameter of the stopper 27 is smaller than the internal diameter of the dropping channel outlet 14 and is larger than the internal diameter of the conical channel area 15.

In the position of the 26 shown here for closing the dropping channel 12, the stopper 27 partially enters the conical channel area 16 of the dropping channel 12. The stopper 27 enters the conical channel area 16 to the extent that the outer circumference of the free end of the stopper 27 is in contact with the inner wall of the conical channel area 16. The dropping channel 12 is closed as a result and a fluid is prevented from being discharged.

Furthermore, the cap 26 has a flange 28, which is coaxial to the cylindrical stopper 27 and is coaxial to the cylinder element 11 in the closed position. The flange 28 has a ring-shaped design and, in the position of the cap 26 for closing the stopper 10, it extends from the cap 26 in the direction of the dropper 10 or the collection area 21. In the position of the cap 26 for closing the dropper 10, the flange 28 is in contact with an inner side of the collection area 21 formed by the ring 22. In the area of an end face 29 of the ring 22, the cap 26 has an opening 30. Furthermore, in the position for closing the dropper 10, the cap 26 is in contact with an outer side 31 of the ring 22, which said outer side faces away from the collection area 21.

The present invention will be explained in more detail below on the basis of FIGS. 1 and 2.

The dropper 10 can be inserted by means of the insertion base 23 into the opening of a neck of a container, which is not shown specifically here. A fluid being stored in the container can be dispensed in the form of drops in a metered manner by means of the dropper 10. The fluid now enters first an interior space of the insertion base 23. It is guaranteed by means of the notches 24, 25 that small residual quantities will also enter the dropper 10 from the container. An at least more or less complete emptying of the container is made possible hereby.

When wetting the dropper 10, the fluid enters the cylindrical channel area 15 through the dropping channel inlet 13. The entry of the fluid through the dropping channel inlet 13 can generate a nonuniform flow. The fluid forms an at least largely uniform, stationary and reproducible flow within the cylindrical channel area 15. This established flow can be continued and maintained in the area of the transition from the cylindrical channel area 15 into the conical channel area 16 and within the conical channel area 16.

Moreover, the cylindrical channel area 15 is used, combined with the conical channel area 16 following it downstream, to bring about a throttling function or pressure reduction. This pressure reduction facilitates the release of small quantities of fluid or drops with a small volume and diameter. Moreover, the cylindrical channel area 15 brings about a shear load on the fluid flowing through the cylindrical channel area 15. Lower viscosity can thus be achieved for the fluid. The fluid, which is thus thinned, will subsequently enter the conical channel area 16 expanding in the direction of flow.

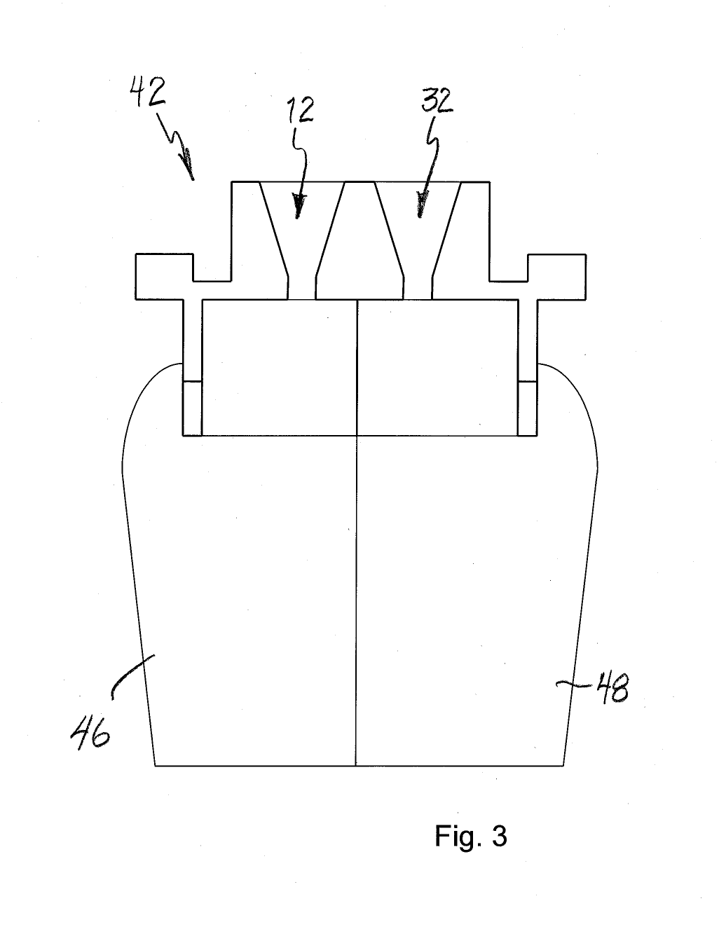

FIG. 3 shows another embodiment with a container and dropper system 42 with a dropper with the dropping channel 12 and also comprising a second dropping channel 32 for a second fluid. The first dropping channel 12 and the second dropping channel 32 are aligned in parallel to one another. The first dropping channel 12 is provided for connection with a first reservoir 46 for the first fluid. The second dropping channel 32 is provided for connection with a second reservoir 48 for the second fluid. The container and dropper system 42 may be provided with a cap with features as shown in FIG. 2, but for both the dropping channel 12 and also the dropping channel 32.

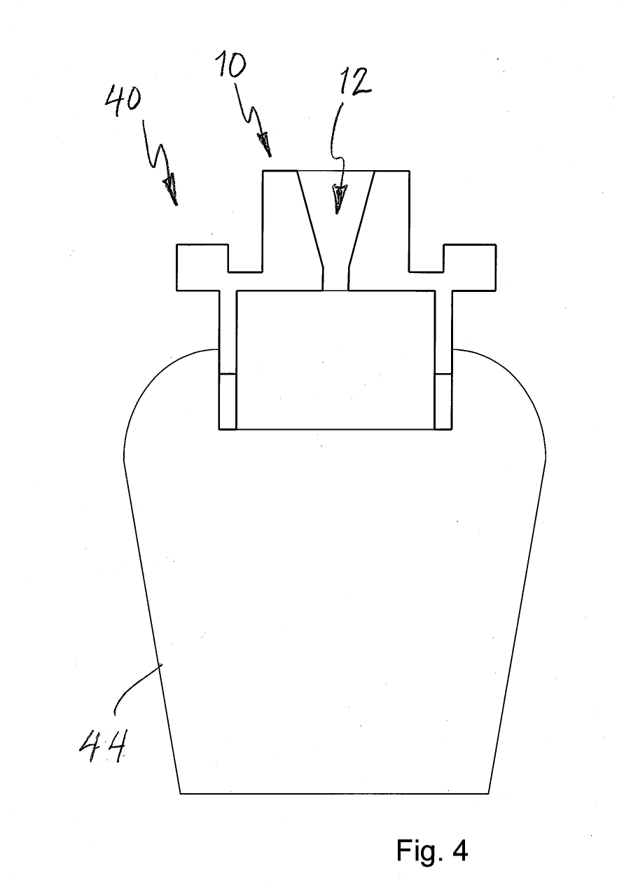

FIG. 4 shows a container and dropper system 40 with a container 44, especially a bottle, with a dropper 10 with the dropping channel 12 according to the present invention or with a dropper-cap system according to the present invention (FIG. 2). Such a container 44 permits smaller drops and/or dispensed quantities to be dispensed in a better meterable manner than before.

While specific embodiments of the invention have been shown and described in detail to illustrate the application of the principles of the invention, it will be understood that the invention may be embodied otherwise without departing from such principles.

### APPENDIX

APPENDIX
List of Reference Numbers:

| | |
|---|---|
| 10 | Dropper |
| 11 | Cylinder element |
| 12 | Dropping channel |
| 13 | Inlet of dropping channel |
| 14 | Outlet of dropping channel |
| 15 | Cylindrical channel area |
| 16 | Conical channel area |
| 17 | Edge |
| 18 | Outer wall |
| 19 | Edge |
| 20 | Inner wall |
| 21 | Collection area |
| 22 | Ring |
| 23 | Insertion base |
| 24 | Notch |
| 25 | Notch |
| 26 | Cap |
| 27 | Stopper |
| 28 | Flange |
| 29 | End face |
| 30 | Opening |
| 31 | Outer side |

What is claimed is:

1. A dropper for dispensing drops of a fluid from a container, the dropper comprising a dropping channel comprising a dropping channel inlet for introducing the fluid into the dropping channel and a dropping channel outlet for dispensing drops from the dropping channel, wherein:
the dropping channel comprises a conical channel area and a cylindrical channel area;
the dropping channel inlet is an end of the cylindrical channel area facing away from the conical channel area; and
the dropping channel outlet is an end of the conical channel area facing away from the cylindrical channel area.

2. A dropper in accordance with claim 1, wherein:
the cylindrical channel area passes over into the conical channel area at a cylindrical channel area end facing away from the dropping channel inlet;
an internal diameter of the conical channel area increases, starting from the cylindrical channel area, in a direction of the dropping channel outlet.

3. A dropper in accordance with claim 1, wherein the cylindrical channel area has a channel length in a range of 0.5 mm to 2.5 mm.

4. A dropper in accordance with claim 1, wherein the cylindrical channel area has a channel length in a range of 0.9 mm to 1.5 mm.

5. A dropper in accordance with claim 1, wherein the cylindrical channel area has an internal diameter in the range of 0.2 mm to 1 mm.

6. A dropper in accordance with claim 1, wherein the cylindrical channel area has an internal diameter in the range of 0.3 mm to 0.5 mm.

7. A dropper in accordance with claim 1, wherein the dropping channel outlet has an internal diameter in the range of 1 mm to 2 mm.

8. A dropper in accordance with claim 1, wherein the dropping channel outlet has an internal diameter in the range of 1.2 mm to 1.5 mm.

9. A dropper in accordance with claim 1, wherein the dropping channel has an overall length comprised of a channel length of the cylindrical channel area and a channel length of the conical channel area, in the range of 4 mm to 8 mm.

10. A dropper in accordance with claim 1, wherein the dropping channel has an overall length comprised of a channel length of the cylindrical channel area and a channel length of the conical channel area, in the range of 5.2 mm to 6.5 mm.

11. A dropper in accordance with claim 1, wherein:
the dropping channel is arranged in a cylinder portion;
the cylinder portion is surrounded by a collection ring area for collecting overflowing and/or excess fluid; and
an insertion base is arranged under at least one of the cylinder portion and the collection area for at least one of inserting and fastening the dropper in an opening of a container.

12. A dropper in accordance with claim 1, wherein the dropping channel is a first dropping channel and further comprising a second dropping channel for a second fluid, wherein:
the first dropping channel and the second dropping channel are aligned in parallel to one another;
the first dropping channel is provided for connection with a first reservoir for the first fluid; and
the second dropping channel is provided for connection with a second reservoir for the second fluid.

13. A dropper-cap system comprising:
a dropper for dispensing drops of a fluid from a container, the dropper comprising a dropping channel comprising a dropping channel inlet for introducing the fluid into the dropping channel and a dropping channel outlet for dispensing drops from the dropping channel, wherein:
the dropping channel comprises a conical channel area and a cylindrical channel area;
the dropping channel inlet is an end of the cylindrical channel area facing away from the conical channel area; and
the dropping channel outlet is an end of the conical channel area facing away from the cylindrical channel area; and
a cap for opening and closing the dropper, wherein:
the cap has a stopper for closing the dropping channel; and
the cap has a ring-shaped flange for coming into contact with an inner side of a collection area of the dropper for closing the collection area of the dropper.

14. A dropper-cap system in accordance with claim 13, wherein:
the dropping channel is arranged in a cylinder portion;
the cylinder portion is surrounded by the collection areas as a collection ring area for collecting overflowing and/or excess fluid; and
an insertion base is arranged under at least one of the cylinder portion and the collection area for at least one of inserting and fastening the dropper in an opening of a container.

15. A dropper-cap system in accordance with claim 13, wherein the dropping channel is a first dropping channel and further comprising a second dropping channel for a second fluid, wherein:
the first dropping channel and the second dropping channel are aligned in parallel to one another;
the first dropping channel is provided for connection with a first reservoir for the first fluid; and
the second dropping channel is provided for connection with a second reservoir for the second fluid.

16. A container comprising:
a bottle; and
a dropper for dispensing drops of a fluid from a container, the dropper comprising a dropping channel comprising a dropping channel inlet for introducing the fluid into the dropping channel and a dropping channel outlet for dispensing drops from the dropping channel, wherein:
the dropping channel comprises a conical channel area and a cylindrical channel area;
the dropping channel inlet is an end of the cylindrical channel area facing away from the conical channel area; and
the dropping channel outlet is an end of the conical channel area facing away from the cylindrical channel area.

17. A container according to claim 16, further comprising:
a cap for opening and closing the dropper, wherein:
the cap has a stopper for closing the dropping channel; and
the cap has a ring-shaped flange for coming into contact with an inner side of a collection area of the dropper for closing the collection area of the dropper.

18. A container in accordance with claim 17, wherein:
the dropping channel is arranged in a cylinder portion;
the cylinder portion is surrounded by the collection areas as a collection ring area for collecting overflowing and/or excess fluid; and
an insertion base is arranged under at least one of the cylinder portion and the collection area for at least one of inserting and fastening the dropper in an opening of a container.

19. A container in accordance with claim 18, wherein the dropping channel is a first dropping channel and further comprising a second dropping channel for a second fluid, wherein:
the first dropping channel and the second dropping channel are aligned in parallel to one another;
the first dropping channel is provided for connection with a first reservoir for the first fluid; and
the second dropping channel is provided for connection with a second reservoir for the second fluid.

20. A container in accordance with claim 18, further comprising:
a dental fluid in said bottle.
